(19) United States
(12) Patent Application Publication
(10) Pub. No.: US 2026/0185568 A1
(43) Pub. Date: Jul. 2, 2026

(54) HAPTIC ACTUATOR USING MAGNETORHEOLOGICAL FLUID CLUTCH APPARATUS

(71) Applicant: EXONETIK INC., Sherbrooke (CA)

(72) Inventors: Guifré JULIO, Westbury (CA); François LESSARD, Sherbrooke (CA)

(21) Appl. No.: 19/129,696

(22) PCT Filed: Dec. 5, 2023
(86) PCT No.: PCT/CA2023/051610

§ 371 Date: May 14, 2025

Related U.S. Application Data
(60) Provisional application No. 63/386,006, filed on Dec. 5, 2022.

(51) Int. Cl. F16D 37/02; G05G 5/03

(52) U.S. Cl. CPC F16D 37/02; G05G 5/03

(57) ABSTRACT

A magnetorheological fluid clutch apparatus may include an input assembly, and an output assembly. An annular space separating shear surfaces of the input assembly from the output assembly. Magnetorheological (MR) fluid in an MR fluid chamber including the at least one annular space, the MR fluid configured to transmit a variable amount of torque between the input assembly and the output assembly when subjected to a magnetic field. A coil(s) actuatable to deliver a magnetic field through the MR fluid in the annular space, the magnetic field controllable to transmit a variable amount of torque from the input assembly to the output assembly. A totality of seal(s) and bearing(s) contacting the output assembly are between the output assembly and the structure.

### CROSS-REFERENCE TO RELATED APPLICATION

The present application claims the priority of U.S. patent application Ser. No. 63/386,006, filed on Dec. 5, 2022 and incorporated herein in its entirety by reference.

### TECHNICAL FIELD

The present application relates generally to magnetorheological (MR) fluid clutch apparatuses, and more particularly, to bodies, devices, systems, organs, etc using such apparatuses for haptic force feedback devices such as collaborative robots, tele-operation systems, tactile cueing systems or simulation systems.

### BACKGROUND OF THE ART

Haptic devices form specific man-machine interfaces. A haptic device may provide operator control and, concurrently, tactile sensations in response to interactions with a technical system. A haptic device provides its user with force-feedback information on the motion and/or force input generated by the user.

Applications for which haptic devices may be used may include robotics, tele-operation, minimally invasive surgery, aircraft inceptors, simulators and computer-based games, among other uses. A characteristic of a haptic device is its force rendering capabilities when an outside force or movement is simulated. To this end, high precision and accuracy actuators may be well suited. Combined with high mechanical stiffness and low mass/inertia, such haptic devices may be used, for example, as robot or manipulator for performing programmed tasks or as a haptic device where force constraints can be applied into the hands of the operator. In another type of application, haptic devices may also be used to provide tactile cueing to aircraft pilots. In such application, the device can provide active tactile cues to the pilot in the form of variable force gradients, stick shaking, and soft stops. Tactile cueing has proven to be an effective method of increasing situational awareness, especially during emergency situations and can reduce pilot workload for increased operational safety.

The combination of haptic feedback device with collaborative robots now being developed show promises for increasing the use of such devices in virtual reality or tele-operation systems, especially in the medical/surgical world, for example. The combination of haptic feedback inceptors with aircraft flight control now being integrated also promises safer piloting. Nonetheless, these known systems could benefit from further improvements. For example, although force feedback systems for surgical robotic applications have been proposed in the past, the added safety concerns and complexity, hence cost of these proposed force feedback systems, has often limited their implementation. Additionally, known force reflecting master/slave robotic arrangements without force sensors may not be ideal for implementation of tactile feedback to the system operator in all the actuation modes.

In light of the above, it would be desirable to provide improved haptic devices, systems, and methods, both for use in robotic tele-operation systems, other robotic applications as well as in aircraft control systems. It would be beneficial if these improvements enhanced the operator's control over, and tactile feedback from, the end effectors. It would further be desirable if these improvements did not unnecessarily complicate systems, and if these improved techniques would improve the safety of the device.

State-of-the-art distributed power devices used in haptic devices and collaborative robots rely on hydraulics or electromagnetic actuation. Hydraulic actuation is reliable relative to mechanical jamming, but has fundamentally limited dynamic response and efficiency. Furthermore, the implementation of hydraulic systems into commercial applications may be problematic as hydraulics are prone to leakage, leading to increased maintenance costs. Moreover, hydraulic actuation is hardware intensive.

Electromagnetic actuation offers a clean alternative to hydraulic actuation. For high dynamic applications, the most common form of electromechanical actuation is found in direct-drive motors, which are prohibitively heavy. Device weight can be considerably reduced by providing a reduction ratio between the motor and the end-effector. Indeed, when coupled to reduction gearboxes, electromechanical actuators are lighter and less expensive than direct drive solutions, but their high output inertia, friction and backlash may diminish their dynamic performance.

Magnetorheological (MR) fluid clutch apparatuses are known as useful apparatuses for transmitting motion from a drive shaft with precision and accuracy, among other advantages, which could enhance the performance of electromechanical haptic systems. Such electromechanical haptic systems may include MR fluid clutches apparatuses that are known to be optimized to minimize the complexity, the friction and inertia on the output side. However, previously proposed MR fluid apparatuses may be subjected to runaways that may cause imprecisions in system controls. Those runaways may be caused by the multiple dynamic interface components (e.g. bearing, seals, slip ring) that may transmit parasitic forces from the input side to the output side of the MR fluid clutch apparatus. Runaway may therefore be defined as an undesired displacement or drift of an output member away from its desired location as a result of such parasitic force(s). State-of-the art MR actuators may need to maintain constant slip between the input and output of MR fluid clutch apparatuses in order to ensure controllability through control of shear of the MR fluid. The input and output are typically located circumferentially about the same rotational axis and are connected using bearings. MR fluid is maintained in a closed volume between input and output using seals. The bearings and/or seals may induce drag that may generate a force between components. In some MR actuators using two counter-rotating MR fluid clutch apparatuses, the forces generated by the dynamic components of the MR fluid clutch apparatus turning clockwise are opposing the forces generated by the dynamic components of the MR fluid clutch apparatus turning counterclockwise. This is also true for the viscous forces generated by the MR fluid in the shear interfaces of respective clockwise and counterclockwise rotating MR fluid clutch apparatuses that are opposing themselves. The residual force on the output may then be negligible. However, in some applications, a slight increase in force generated by any one of the MR fluid clutch apparatuses relative to the other may produce an undesired amount of force at the output. In a tele-operated surgical robot where a master haptic device is controlled in open loop (e.g., without force or torque cell) and is connected to a remote slave robot, if the surgeon removes his/her hand from the haptic master device and the slip between the input components of one MR fluid apparatus generates a parasitic friction force at the seal only slightly higher than the friction force generated by the other MR fluid clutch apparatus, then the haptic device may move in one direction without human intervention, sending an unwanted command to the slave robot to also move.

For all those reasons, there is still a need for a MR active haptic actuation system that limits parasitic forces.

### SUMMARY

It is an aim of the present disclosure to provide novel active haptic motion control systems using magnetorheological fluid clutch apparatuses.

It is a further an aim of the present disclosure to provide a method and system for limiting parasitic forces of a haptic actuator using magnetorheological fluid clutch apparatuses.

It is a further aim of the present disclosure to provide novel haptic surgical actuator using magnetorheological fluid clutch apparatuses.

It is a still further aim of the present disclosure to use such systems in tele-operated robots.

It is a still further aim of the present disclosure to use such systems in aircraft or vehicle devices control systems.

Therefore, in accordance with a first aspect of the present disclosure, there is provided a magnetorheological fluid clutch apparatus comprising: a structure; an input assembly including an input member rotatably mounted to the structure to rotate relative to the structure, and at least one input shear surface rotating with the input member; an output assembly including an output member rotatably mounted to the structure to rotate relative to the structure, and at least one output shear surface rotating with the output member, the at least one output shear surface opposite the at least one input shear surface; at least one annular space separating the shear surfaces; magnetorheological (MR) fluid in an MR fluid chamber including the at least one annular space, the MR fluid configured to transmit a variable amount of torque between the input assembly and the output assembly when subjected to a magnetic field; at least one coil actuatable to deliver a magnetic field through the MR fluid in the annular space, the magnetic field controllable to transmit a variable amount of torque from the input assembly to the output assembly; wherein a totality of seal(s) and bearing(s) contacting the output assembly are between the output assembly and the structure.

Further in accordance with the first aspect, for example, the input assembly includes input drums, and the at least one input shear surface is on the input drums.

Still further in accordance with the first aspect, for example, the output assembly includes output drums, and the at least one output shear surface is on the output drums.

Still further in accordance with the first aspect, for example, the output drums are intertwined with the input drums, with the annular spaces therebetween.

Still further in accordance with the first aspect, for example, the input assembly includes an input rotor forming an outer casing of the MR fluid clutch apparatus.

Still further in accordance with the first aspect, for example, the MR fluid chamber is delimited outwardly by the input rotor.

Still further in accordance with the first aspect, for example, the structure has support portion thereof delimiting the MR fluid chamber.

Still further in accordance with the first aspect, for example, the support portion is connected to the input rotor by at least one bearing, and connected to the output member by at least one other bearing.

Still further in accordance with the first aspect, for example, a seal may be between the MR fluid chamber and the bearing, and another seal between the MR fluid chamber and the other bearing.

Still further in accordance with the first aspect, for example, the output assembly includes an output rotor forming an outer casing of the MR fluid clutch apparatus.

Still further in accordance with the first aspect, for example, the MR fluid chamber is delimited outwardly by the output rotor.

Still further in accordance with the first aspect, for example, a total of friction forces between the output assembly and the structure is higher than viscous forces generated at the shear surface of the MR fluid clutch apparatus in a slippage mode.

Still further in accordance with the first aspect, for example, the MR fluid clutch apparatus is without any dynamic interface component directly between the input assembly and the output assembly.

In accordance with a second aspect of the present disclosure, there is provided a haptic magnetorheological (MR) fluid actuator unit comprising: at least one torque source; a structure; at least a pair of magnetorheological fluid clutch apparatuses, each of the magnetorheological fluid clutch apparatuses having: an input assembly including an input member rotatably mounted to the structure to rotate relative to the structure, and at least one input shear surface rotating with the input member; an output assembly including an output member rotatably mounted to the structure to rotate relative to the structure, and at least one output shear surface rotating with the output member, the at least one output shear surface opposite the at least one input shear surface; at least one annular space separating the shear surfaces; magnetorheological (MR) fluid in an MR fluid chamber including the at least one annular space, the MR fluid configured to transmit a variable amount of torque between the input assembly and the output assembly when subjected to a magnetic field; and at least one coil actuatable to deliver a magnetic field through the MR fluid in the annular space, the magnetic field controllable to transmit a variable amount of torque from the input assembly to the output assembly; wherein the output member of the pair of magnetorheological fluid clutch apparatuses being a common output member; wherein a totality of seal(s) and bearing(s) contacting the output assembly are between the output assembly and the structure.

Further in accordance with the second aspect, for example, the input assembly includes input drums, and the at least one input shear surface is on the input drums.

Still further in accordance with the second aspect, for example, the output assembly includes output drums, and the at least one output shear surface is on the output drums.

Still further in accordance with the second aspect, for example, the output drums are intertwined with the input drums, with the annular spaces therebetween.

Still further in accordance with the second aspect, for example, the common output member includes an output rotor forming an outer casing of the MR fluid clutch apparatuses.

Still further in accordance with the second aspect, for example, the MR fluid chamber is delimited outwardly by the output rotor.

Still further in accordance with the second aspect, for example, a total of friction forces between the output assembly and the structure is higher than viscous forces generated at the shear surface of the MR fluid clutch apparatus in a slippage mode.

Still further in accordance with the second aspect, for example, the MR fluid clutch apparatus is without any dynamic interface component directly between the input assembly and the output assembly.

In accordance with a third aspect of the present disclosure, there is provided a haptic magnetorheological (MR) fluid actuator unit between bodies comprising: at least one torque source; at least one input receiving torque from the at least one torque source; an output; a structure rotatably supporting the input and the output; and at least one MR fluid clutch apparatus between the input and the output, the MR fluid clutch apparatus controllable to transmit a variable amount of torque from the input to the output; wherein a totality of seal(s) and bearing(s) contacting the output are between the output and the structure.

In accordance with a fourth aspect of the present disclosure, there is provided a haptic magnetorheological (MR) actuator unit between bodies comprising: at least one torque source; at least one input receiving torque from the at least one torque source; an output; a structure rotatably supporting the input and the output; and at least one MR fluid clutch apparatus between the input and the output, the MR fluid clutch apparatus controllable to transmit a variable amount of torque from the input to the output; wherein the MR actuator unit is without seal(s) and bearing(s) being directly between the input and the output.

In accordance with a fifth aspect of the present disclosure, there is provided a haptic magnetorheological (MR) actuator unit between bodies comprising: at least one torque source; at least one input receiving torque from the at least one torque source; an output; a structure rotatably supporting the input and the output; and at least one MR fluid clutch apparatus between the input and the output, the MR fluid clutch apparatus controllable to transmit a variable amount of torque from the input to the output; wherein friction force(s) between the output and the structure is higher than viscous forces generated at shear interfaces of the MR fluid clutch apparatus in a slippage mode.

### DESCRIPTION OF THE DRAWINGS

FIG. 1 is a schematic view of a generic magnetorheological (MR) fluid clutch apparatus of the prior art;

FIG. 2 is a sectioned schematic view of the MR fluid clutch apparatus of FIG. 1;

FIG. 3a is a representation of a MR fluid actuator using a single motor and a single clutch;

FIG. 3b is a representation of a MR fluid actuator using a single motor and a single clutch as the last mechanical element of the actuator;

FIG. 4a is a representation of a MR fluid actuator using a single motor and double clutch;

FIG. 4b is a representation of a MR fluid actuator using a single motor and double clutch as the last mechanical elements of the actuator;

FIG. 5a is a representation of two MR fluid actuators organized in a parallel path;

FIG. 5b is a representation of two MR fluid actuators organized in a parallel path and having the clutches as the last mechanical elements of the actuator;

FIG. 6 is a schematic representation of a single degree of freedom actuator of in accordance with an embodiment;

FIG. 7 is a detailed representation of the rotary MR fluid actuator of FIG. 6;

FIG. 8 is a schematic representation of a variant of a linear MR fluid actuator using a rack and pinion couple with a single motor and a single clutch; and

FIG. 9 is a sectioned schematic view of a MR fluid clutch apparatus that may be used in the linear MR fluid actuator of FIG. 8.

### DETAILED DESCRIPTION

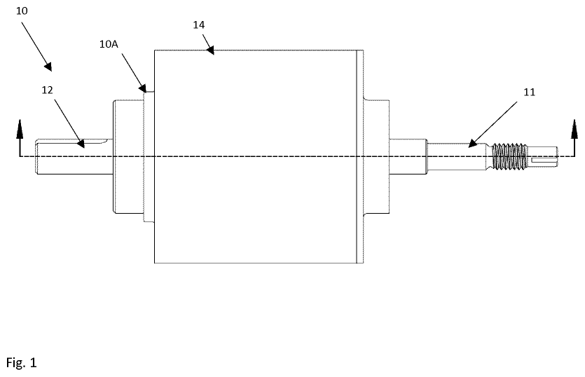

Referring to the drawings and more particularly to FIG. 1, there is illustrated a state of the art magnetorheological (MR) fluid clutch apparatus 10 configured to provide a mechanical output force based on a received input current. The MR fluid clutch apparatus 10 is shown as being of the type having collinear input and output shafts. However, the concepts described herein may apply to other configuration of MR fluid clutch apparatuses, for instance some with an input or output outer shell/casing for an output or input shaft, etc. The principles illustrated here will be performed using a MR fluid clutch apparatuses of drum type but could also be applied to a disc type MR fluid clutch apparatus. Magnet or magnets may also be introduced in the magnetic circuit in order for the MR fluid clutch apparatus 10 to provide a torque when not powered.

The MR fluid clutch apparatus 10 may provide an output force in response to an input current received from an operator, to transmit an input force and an output force based on the magnetization level of a magnetizable part in the magnetic circuit when there is no input current. The exemplary MR fluid clutch apparatus 10 may have a stator 10A′ to which the MR fluid clutch apparatus 10 is connected to a structure. The stator 10A′ may be regarded as a structure of the MR fluid clutch apparatus 10, in that it does serves as a rotational support for rotating components of the MR fluid clutch apparatus 10. Therefore, the expressions stator and structure may be used interchangeably in the present disclosure, to refer to part of the MR fluid clutch apparatus 10 that rotatably supports a driving member(s) or input, and a driven member(s) or output. The stator/structure 10A′ may support coils but this is optional. The MR fluid clutch apparatus 10 features driven member 11 and driving member 12 separated by gaps filled with an MR fluid, as explained hereinafter. The driving member 12 may receive rotational energy (torque) from a power device, such as a motor, with or without a transmission, such as a reduction gear box, etc.

According to an embodiment, the driving member 12 may be in mechanical communication with a power input (i.e., a torque source), and driven member 11 may be in mechanical communication with a power output (i.e., force output, torque output). The stator 10A′, the driven member 11 and the driving member 12 may be interconnected by bearings 12A and 12B. In the illustrated embodiment, the bearing 12A is between the stator 10A′ and the driving member 12, whereas the bearing 12B is between the driven member 11 and the driving member 12. Seals 12C may also be provided at the interface between the driven member 11 and the driving member 12, to preserve MR fluid between the members 11 and 12. Moreover, the seals are provided to prevent MR fluid from reaching the bearing 12B or to leak out of the apparatus 10.

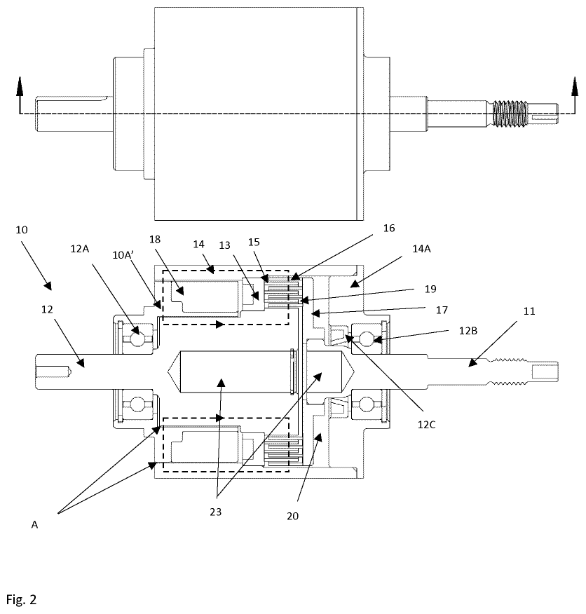

As shown with reference to FIG. 2, drums are located circumferentially about the rotational axis CL. Some support must therefore extend generally radially to support the drums in their circumferential arrangement. In accordance with one embodiment, referring to FIG. 2, a low permeability input drum support 13 (a.k.a., radial wall) projects radially from a shaft of the driving member 12. The input drum support 13 may be connected to an input rotor 14 defining the outer casing or shell of the MR fluid clutch apparatus 10. The input rotor 14 may therefore be rotatably connected to the driven member 11 by the bearing 12B. In an embodiment, the input rotor 14 has an input rotor support 14A which forms a housing for the bearing 12B. According to an embodiment, the input rotor support 14A is an integral part of the input rotor 14, and may be fabricated as a single piece. However, this is not desirable as the input rotor support 14A is ideally made from a low permeability material and the input rotor is made from a high permeability material. As another embodiment, as shown in FIG. 2, the input rotor support 14A may be defined by an annular wall fabricated separately from a remainder of the input rotor 14, though both are interconnected for concurrent rotation. Therefore, the shaft of the driving member 12, the input drum support 13 and the input rotor 14 rotate concurrently. In an embodiment, it is contemplated to have the outer shell of the MR fluid clutch apparatus 10 be part of the stator 10A, or of the driven member 11.

The input drum support 13 may support a plurality of concentric annular drums 15, also known as input annular drums. The input annular drums 15 are secured to the input drum support 13. In an embodiment, concentric circular channels are defined (e.g., machined, cast, molded, etc) in the input drum support 13 for insertion therein of the drums 15. A tight fit (e.g., force fit), an adhesive and/or radial pins may be used to secure the drums 15 to the input drum support 13. In an embodiment, the input drum support 13 is monolithically connected to the shaft of the driving member 12, whereby the various components of the driving member 12 rotate concurrently when receiving the drive from the power source.

The driven member 11 is represented by an output shaft, configured to rotate about axis CL as well. The output shaft may be coupled to various mechanical components that receive the transmitted power output when the clutch apparatus 10 is actuated to transmit at least some of the rotational power input.

The driven member 11 also has a one or more concentric annular drums 16, also known as output drums, mounted to an output drum support 17. The output drum support 17 may be an integral part of the output shaft, or may be mounted thereon for concurrent rotation. The annular drums 16 are spaced apart in such a way that the sets of output annular drums 16 fit within the annular spaces between the input annular drums 15, in intertwined fashion. When either of both the driven member 11 and the driving member 12 rotate, there is no direct contact between the annular drums 15 and 16, due to the concentricity of the annular drums 15 and 16, about axis CL. Electromagnetic coil 18 is an example of a component generating a magnetic field, observed in the dotted circuit in FIG. 2 and in other figures. The coil 18 is actuated to control the torque transmitted by MR fluid clutch apparatus 10.

In this configuration, bearing 12B and seal 12C may transmit parasitic forces from the input support 14A to the driven member 11 when input support 14A is not turning at the same speed as the driven member 11. Parasitic force from bearing 12B may be produced by the friction of the internal components, which friction is not constant and may depend on certain tribological phenomena that occur in the lubricant film between the rolling elements, raceways and cages. Parasitic force of the seal 12C may be produced by friction force between the seal 12C and the driven member 11 and is not constant and depends on certain factors like material, tribological phenomena in the lubricant, pressure, temperature and contamination coming from wear, amongst other.

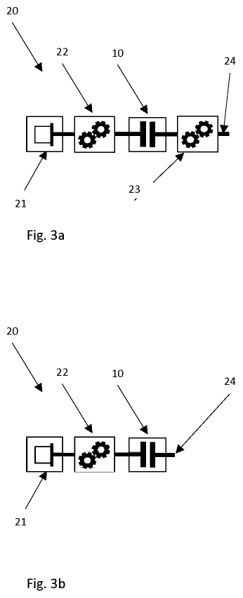

According to FIGS. 3a and 3b, a MR fluid actuator 20 (also known as a MR fluid actuator unit) is shown having a MR fluid clutch apparatus 10 of the type described herein, without dynamic interfacing component between input and output, as defined below. The actuator of FIG. 3a is composed of a motor 21, an input gearbox 22, a MR fluid clutch apparatus 10, an output gearbox 23 and an output 24, though one or both of the gearboxes may be optional, as shown on FIG. 3b where there is no gearbox between the driven member 11 of the MR fluid clutch apparatus 10 and the output 24. Also, any MR fluid actuator 20 may be complement with sensors to indicate the position (e.g. position sensor), acceleration (e.g. acceleration sensor) or torque/force (e.g. torque or force sensor) generated by the MR fluid actuator 20. In a variant, in a basic configuration, a MR fluid actuator such as that shown as 20 has a motor 21 and a MR fluid clutch apparatus 10.

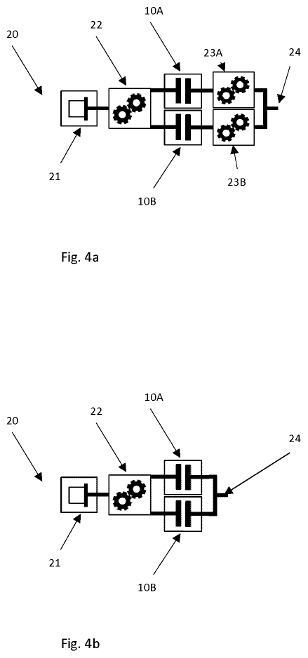

Another type of MR fluid actuator 20 is shown on FIG. 4a and is composed of a single motor, an input gearbox 22, two MR fluid clutches 10A and 10B, turning in opposite direction an applying antagonistic forces on the output 24, each through gearbox 23A and 23B. Again, as shown on FIG. 4b it is possible that there is no gearbox between the driven members 11A and 11B of the MR fluid clutch apparatus 10A and 10B and the common output 24. The MR fluid actuators 20 of FIGS. 4a and 4b may be without dynamic interfacing component between input and output, as defined below.

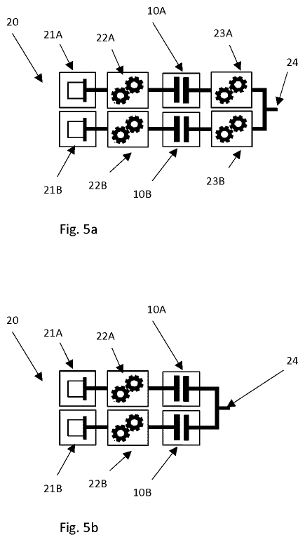

Another type of MR fluid actuator 20 is shown in FIGS. 5a and 5b and is composed of two MR fluid actuators similar to the one of FIGS. 3a and 3b respectively, working in parallel in order to apply a force on a single output 24. The MR fluid actuators 20 of FIGS. 5a and 5b may be without dynamic interfacing component between input and output, as defined below. In FIG. 5a, the first branch of actuation is composed of a motor 21A, an input gearbox 22A, a MR fluid clutch 10A, an output gearbox 23A driving the output 24. The first second branch of actuation is composed of a motor 21B, an input gearbox 22B, a MR fluid clutch 10B, an output gearbox 23B driving the same output 24. Again, as shown on FIG. 5b it is possible that there is no gearbox between the driven members 11A and 11B of the MR fluid clutch apparatus 10A and 10B and the common output 24. It is to be noted that for a reason of simplicity, the explanation provided is for the control of one degree of freedom, but multiple MR fluid actuators could be used to control multiple degrees of freedom of the body. Moreover, the multiple MR fluid clutch apparatuses could share the same power source, as is the case in FIG. 3 with both MR fluid clutch apparatuses 10 receiving the actuation power from the single motor 21, via a transmission 22. The transmission 22 is illustrated as featuring a gearbox but pulleys and belts may be used. Transmission 22 but may also be of other type such as a, chain and pinions, etc., only to name a few. Other devices can be used as variable force sources or biasing member.

The combination of a variable power source with the MR fluid clutch apparatus(es) 10 presents advantages of a hybrid system where one device or the other (or both simultaneously) can be controlled depending on the condition of operation. In an example where the power source is an electric motor, the electric motor speed and available torque can be controlled as well as the torque transmitted by the MR fluid clutch apparatus(es) 10. This may increase the potential points of operation while increasing the overall performance or efficiency of the system. The output of the MR fluid clutches can be decoupled from the input. In some application, this can be useful to decouple the inertia from the input in order not to affect the time of response of the output.

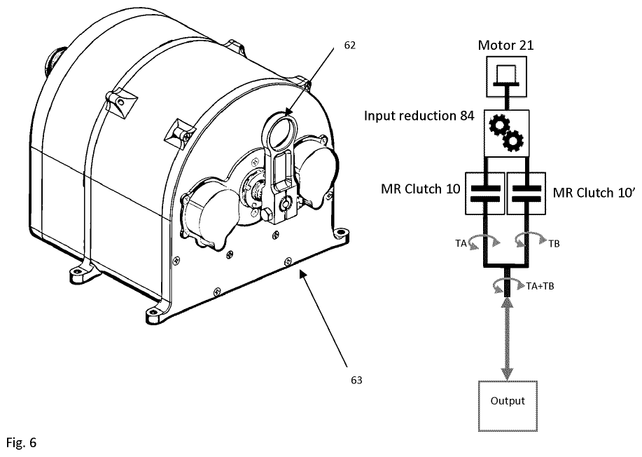

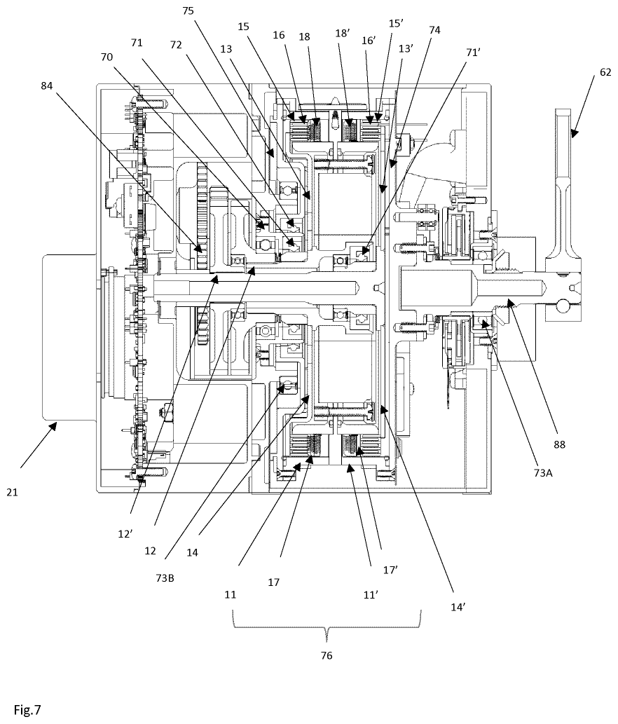

Referring to FIGS. 6 and 7, a configuration of FIG. 4b is illustrated, in which MR fluid clutch apparatuses 10 and 10′ are integrated in a common single housing. The system shown in FIGS. 6 and 7 may for instance by used as a trim actuator in an aircraft (e.g., rotorcraft), such as in a fly-by-wire configuration, with the system of FIGS. 6 and 7 being a haptic trim actuator used to provided haptic feedback to a pilot. The system of FIGS. 6 and 7 may also be used in other types of vehicles, such as road vehicles, as part of a steer-by-wire system. A trim actuator may generally be defined as a system that interfaces with a flight control system to control the mechanical flight controls of the aircraft.

Like the assembly of FIG. 4b that uses no reduction mechanism at the output (though it could), the MR fluid clutch apparatuses 10 and 10′ in FIGS. 6 and 7 respectively having driven members 11 and 11′ that are connected to a single actuator output member 88 through a mechanical assembly (bolt, press fit, bonded, etc), connected to an output lever 62, as one possible output device (others including a gear, a pulley, etc). In FIGS. 6 and 7, the MR fluid clutch apparatuses 10 and 10′ have a common output assembly. Reduction mechanism 84 may be present to couple the motors in the casing to the driving members 12 and 12′. If the system of FIGS. 6 and 7 is used as a haptic trim actuator, the output lever 62 may be connected to the pilot input device, such that the output lever 62 is driven to provide force feedback emulating trim. As part of the input assembly, the shafts of the driving members 12 and 12′ and the input drum supports 13 and 13′, respectively, rotate concurrently. The input drum supports 13 and 13′ may optionally be an integral part of the shafts of the driving members 12 and 12′, respectively. The input drum support 13 and 13′ may support a plurality of concentric annular drums 15 and 15′, respectively, also known as input annular drums. The input annular drums 15 and 15′ are secured to the input drum supports 13 and 13′, respectively. As part of the output assembly, the driven members 11 and 11′ also have one or more concentric annular drums 16 and 16′, respectively, also known as output drums, mounted to output drum supports 17 and 17′. The output drum supports 17 and 17′may optionally be an integral part of the output shaft or may be mounted thereon for concurrent rotation, but are illustrated as being connected to a casing of a cover 74, also referred to as an output rotor. While input and output drums are shown, the MR fluid clutch apparatuses 10 and 10′ may employ disks (a.k.a., discs) as an alternative. Coils 18 and 18′ are actuated to control the torque transmitted by MR fluid clutch apparatuses 10 and 10′. In the illustrated embodiment, there are seals 71 and 71′that maintain pressure on input members 12 and 12′ respectively, to prevent the MR fluid 19 from escaping their fluid chambers within the MR fluid clutch apparatuses 10 and 10′. The seal 71 is installed between a section of the static frame 70 and the input member 12, and the seal 71′ is installed between the input members 12 and 12′, though other arrangements are possible. In the illustrated embodiment of FIGS. 6 and 7, there is shown a common MR fluid chamber of the type described in U.S. Pat. No. 11,092,201, incorporated herein by reference. However, embodiments with independent MR fluid chambers are also possible, for each of the MR fluid clutch apparatuses 10 and 10′. The output member 88 is rigidly attached to a cover 74 that may include a cover plate connected directly to the output member 88, and the casing portion (a.k.a., output rotor) that delimits the MR fluid chamber radially outwardly, as shown, all part of the output assembly. The casing portion may further be connected to the static frame 70 by way of cover 75. The driven members 11 and 11′, and a cover 75 (e.g., a cover plate) may rotate using bearings 73A and 73B to form an output assembly 76. Stated differently, the output assembly includes an output rotor that has the covers 74 and 75, with casing portion between them, outward of the fluid chamber, and defining it. The covers 74 and 75 and thus the output assembly 76 is rotatably supported by bearings 73A and 73B that are mounted to the static frame 70. The output seal 72 also turns on a portion of the static frame 70. Accordingly, the assembly of FIGS. 6 and 7, featuring the MR fluid clutch apparatuses 10 and 10′, has all dynamic interfacing components (e.g., bearings and seals) associated with the output assembly 76, between the output assembly 76 and the static frame 70. Stated differently, in the assembly of FIGS. 6 and 7, featuring the MR fluid clutch apparatuses 10 and 10′, there is no dynamic interfacing components (e.g., bearings and seals) between input and output. Of course, MR fluid may transmit torque between input and output, but the absence of dynamic interfacing components (e.g., bearings and seals) between input and output prevents any torque that could be generated by the components on the input side of the MR fluid 19 to be transmitted to any of the components of the output assembly 76 through the bearings and/or seals. Torque TA and TB (FIG. 6) only depend on the fluidic viscous coupling of the MR fluid 19 between the input members and the output members of the MR fluid clutch apparatuses 10 and 10′ for torque transmission. Since fluidic viscous coupling forces in slippage mode are generally lower than the friction forces generated by the bearings and/or seals, the resulting force may be lower than the friction forces between the output assembly 76 and the static frame 70. This arrangement prevents runaway conditions that may be specific to a MR fluid actuator that uses a slip interface. The expression “dynamic interfacing component” may be defined as a mechanical component(s), set of component(s), assembly of component(s) that is(are) at the interface between parts that move relative to one another. Thus, such dynamic interfacing component may be in contact with both of the parts that move relative to one another. For example, a bearing between two shafts may be regarded as being a dynamic interfacing component between the two shafts, whether both of the shafts or a single one of the shafts rotates. Likewise, a seal, a gasket between two shafts may be regarded as being a dynamic interfacing component between the two shafts, whether both of the shafts or a single one of the shafts rotates. Moreover, while the examples pertain to two shafts, dynamic interfacing components may be between other sets of components that more relative to one another, such as a shaft and a structure.

Runaway may be induced when torque TA is not perfectly equal to torque TB. In comparison to MR fluid clutch apparatuses having seals and/or bearing between input component(s) and output component(s), the arrangement of FIGS. 6 and 7 may decrease the efficiency of the MR fluid actuator. Since the motor or other power source has to overcome the friction of more seals (e.g., three seals in FIGS. 6 and 7) that are required to seal the MR fluid 19 in the chamber, when it may have been possible to seal the same interface by using only two seals, one between the output assembly 76 and the input member 12 and one between the input members 12 and 12′. It is nevertheless preferable to use these arrangements to reduce or prevent runaway in some embodiments in which runaway must be limited. Other configurations having two seals or only one seal may also be possible. Also, a rotary output is shown here but may also be replaced by a linear type of mechanism (e.g., ball screw, roller screw, rack and pinion, lever arm). The embodiment of FIGS. 6 and 7, or of other embodiments described herein, may also be used as part of a haptic actuators.

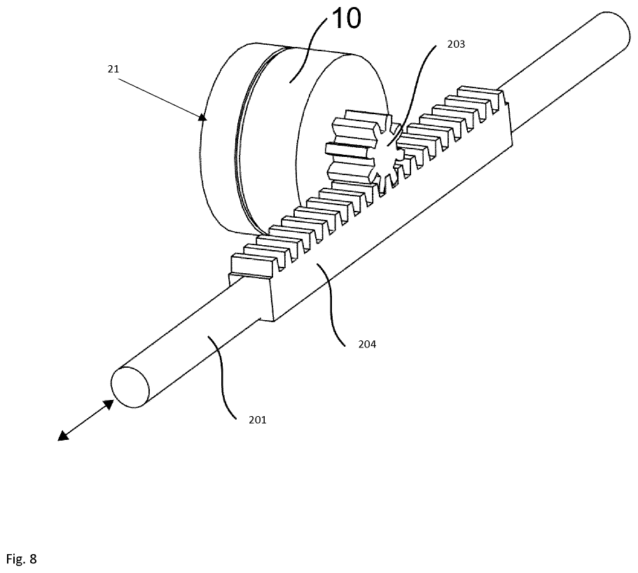

Moreover, although FIGS. 6 and 7 show a haptic actuator having a pair of MR fluid clutch apparatuses, it is considered to provide individual MR fluid clutch apparatuses without bearings or seals between input and output as described above. For example, the system of FIGS. 6 and 7, could have a single MR fluid clutch apparatuses, i.e., an input assembly featuring only one of the input members 12 and 12′. For example, FIG. 8 shows a single-motor single-clutch actuator system. A single MR fluid clutch apparatus 10 is used, with a pinion 203 on a structural link 201, acting as an MR fluid brake or actuator by providing braking or actuation of the movement of the structural link 201 in the unbiased direction by applying a force on rack portion 204. Again, other types of linear mechanisms (e.g., ball screw, roller screw, rack and pinion, lever arm) may be used. The motor 21 may be a uni-directional or bi-directional motor in an embodiment. In such a MR fluid motion control system, the motor 21 and the MR fluid clutch apparatus 10 may have to reverse their movements, a.k.a., change or switch in direction, (e.g., CW to CCW or vice versa, X translation to −X translation or vice versa). For example, an arrangement includes motor 21, an optional input reduction mechanism (embedded and not shown in FIG. 8), and MR fluid clutch apparatus 10 where the input member 12 spins at a different speed than the output member 11 to provide a slipping condition decoupling the input inertia from the output. The slip direction within the MR fluid clutch apparatus 10 controls the direction of the output torque (positive or negative). A slip direction reversal may happen when the MR fluid clutch apparatus 10 slip changes direction, such as: A) when the input member 12 initially spins faster than the output member 11 and transitions to a state where it spins slower than the output member 11, reversing from a positive torque to a negative torque; B) when the input member 12 initially spins slower than the output member 11 and transitions to a state where it spins faster than the output member 11, reversing from a negative torque to a positive torque. There may be benefit of having such a system with zero output force created at the output, despite the slip between the input and the output that may vary. An arrangement where all the contacting parts between the output are referenced on a static portion (i.e., coupled to a static portion) of the frame may have advantages. The expression dynamic interfacing component is used to describe devices such as seals of any type, such as O-rings, cup seals, wiper seals, gaskets, etc, and that form a joint between components moving relative to one another, such as the output member 11 and the static frame or like structure. The expression dynamic interfacing component is also used to describe devices such as bearings of any type, such as ball bearings, roller bearings, plain bearings, etc, and that form an interface between components moving relative to one another, such as the output member 11 and the static frame or like structure. In a variant, it may be said that a totality of seal(s) and bearing(s) contacting the output are between the output and the structure, avoiding any dynamic interfacing component directly between the input and output, so as not to enable parasitic force transmission via such a dynamic interfacing component and caused by relative movement between input and output. In a variant, it may be said that the MR actuator unit is without seal(s) and bearing(s) being directly between the input and the output. In a variant, it may be said that friction(s) force between the output and the structure is higher than viscous forces generated at shear interfaces of the MR fluid clutch apparatus in a full slippage mode (e.g., with the coils not actuated, with viscosity kept as low as possible), whereby any incident parasitic force caused by the viscous forces in spite of the slippage mode would be insufficient to cause runaway. For this, it may be desired to select components having an inherent friction or causing sufficient friction to oppose greater frictional forces than viscous forces. For example, a seal may be used with a force fit or interference fit, and/or with a selected coefficient of friction and/or sizable contact surface between an output component and the structure.

The system of FIGS. 6 and 7 may generally be described as being a haptic magnetorheological (MR) fluid actuator unit that may have at least one torque source; a structure; at least a pair of magnetorheological fluid clutch apparatuses, each of the magnetorheological fluid clutch apparatuses having: an input assembly including an input member rotatably mounted to the structure to rotate relative to the structure, and at least one input shear surface rotating with the input member; an output assembly including an output member rotatably mounted to the structure to rotate relative to the structure, and at least one output shear surface rotating with the output member, the at least one output shear surface opposite the at least one input shear surface; at least one annular space separating the shear surfaces; magnetorheological (MR) fluid in an MR fluid chamber including the at least one annular space, the MR fluid configured to transmit a variable amount of torque between the input assembly and the output assembly when subjected to a magnetic field; and at least one coil actuatable to deliver a magnetic field through the MR fluid in the annular space, the magnetic field controllable to transmit a variable amount of torque from the input assembly to the output assembly; wherein the output member of the pair of magnetorheological fluid clutch apparatuses being a common output member; wherein a totality of seal(s) and bearing(s) contacting the output assembly are between the output assembly and the structure.

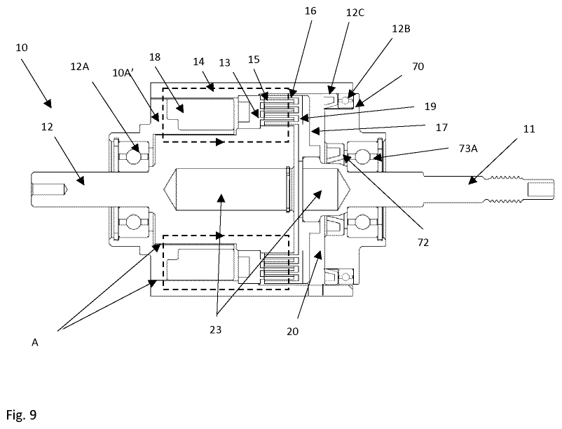

The type of MR fluid clutch apparatus 10 used in the set up of FIG. 8 may be the one shown in FIG. 9. The MR fluid clutch apparatus 10 of FIG. 9 may also be used in other systems. The MR fluid clutch apparatus 10 of FIG. 9 has an assembly and components similar to those of the MR fluid clutch apparatus 10 of FIG. 2, whereby like elements will bear like reference numerals. The exemplary MR fluid clutch apparatus 10 may optionally have a structure 10A′ to which the MR fluid clutch apparatus 10 is connected to another structure, exterior to the MR fluid clutch apparatus 10. The MR fluid clutch apparatus 10 features the driven member 11, a.k.a., the output or output member 11, and driving member 12, a.k.a., the input or input member 12, separated by gaps filled with an MR fluid, as explained hereinafter. The driving member 12 may be part of the input assembly and may receive rotational energy (torque) from a power device, such as a motor, with or without a transmission, such as a reduction gear box, etc.

Input drum support 13 (a.k.a., radial wall) may also be part of the input assembly and projects radially from a shaft of the driving member 12. The input drum support 13 may be connected to an input rotor 14 of the input assembly, the input rotor 14 defining the outer casing or shell of the MR fluid clutch apparatus 10. The input drum support 13 may support a plurality of concentric annular drums 15, also known as input annular drums. The input annular drums 15 are secured to the input drum support 13. In an embodiment, concentric circular channels are defined (e.g., machined, cast, molded, etc) in the input drum support 13 for insertion therein of the drums 15. A tight fit (e.g., force fit), an adhesive, welding, brazing, and/or radial pins may be used to secure the drums 15 to the input drum support 13. In an embodiment, the input drum support 13 is monolithically connected to the shaft of the driving member 12, whereby the various components of the driving member 12 rotate concurrently when receiving the drive from the power source. Other types of shear surfaces may be used, such as disks instead of drums, as part of the input assembly

The output assembly may include the driven member 11. The driven member 11 also has one or more concentric annular drums 16, also known as output drums, mounted to an output drum support 17, for instance as part of the output assembly. This is merely an option, as the shear surfaces may also be disks of the output assembly. The output drum support 17 may be an integral part of the output shaft, or may be mounted thereon for concurrent rotation. The annular drums 16 are spaced apart in such a way that the sets of output annular drums 16 fit within the annular spaces between the input annular drums 15, in intertwined fashion. When either of both the driven member 11 and the driving member 12 rotate, there is no direct contact between the annular drums 15 and 16, due to the concentricity of the annular drums 15 and 16. Electromagnetic coil 18 is an example of a component generating a magnetic field, observed in the dotted circuit in FIG. 9. The coil 18 may be fixed to the structure 10A′, though it could be mounted to other parts of the MR fluid clutch apparatus 10 of FIG. 9 (e.g., to the input assembly). The coil 18 is actuated to control the torque transmitted by MR fluid clutch apparatus 10. In any of the embodiments described herein, other components may be used to contribute to directing the magnetic field, including permanent magnet(s), air gaps, etc. Moreover, resilient members 23, such as closed-cell foam may be inside the driven member 11 and/or the drive member 12 and exposed to the MR fluid in the fluid chamber, to compress as a function of MR fluid expansion, to assist in controlling a pressure of the MR fluid. The resilient members 23 are optional.

In the illustrated embodiment of FIG. 9, the seal 12C maintains pressure on input rotor 14, to prevent the MR fluid 19 from escaping the fluid chamber of the MR fluid clutch apparatus 10. The seal 12C is installed between a section of the static frame 70 (e.g., part of the structure 10A′, a.k.a., cover, cover plate) and the input rotor 14. In the illustrated embodiment, the bearing 12A is between the structure 10A′ and the driving member 12, whereas the bearing 12B is between the input rotor 14 and the static frame 70. Thus, there is no bearing directly between the driving member 12 and the drive member 11. The output member 11 may be rotatably supported by bearing 73A, that is also supported by the static frame 70. The output seal 72 that contacts the output member 11 may also turn with the static frame 70. The output member 11 is only guided and sealed with components that are interfaced to the static frame 70 or like structural component of the MR fluid clutch apparatus 10, and not the driving member 12. In a variant, the output seal 72 is selected so as to provide some friction value sufficient to ensure that no parasitic force is transmitted to the drive member 11, in a scenario in which the static frame 70 is a cover plate that is not secured to a remainder of the structure 10A′. For example, frame 70 could be a cover plate that is rotatably supported between the input 14 and the output 11, by bearings 12B and 73A, respectively.

The magnetorheological fluid clutch apparatus of FIG. 9 may be described as having a structure; an input assembly including an input member rotatably mounted to the structure to rotate relative to the structure, and at least one input shear surface rotating with the input member; an output assembly including an output member rotatably mounted to the structure to rotate relative to the structure, and at least one output shear surface rotating with the output member, the at least one output shear surface opposite the at least one input shear surface; at least one annular space separating the shear surfaces; magnetorheological (MR) fluid in an MR fluid chamber including the at least one annular space, the MR fluid configured to transmit a variable amount of torque between the input assembly and the output assembly when subjected to a magnetic field; at least one coil actuatable to deliver a magnetic field through the MR fluid in the annular space, the magnetic field controllable to transmit a variable amount of torque from the input assembly to the output assembly; wherein a totality of seal(s) and bearing(s) contacting the output assembly are between the output assembly and the structure.

The embodiments described from FIGS. 6 to 9, wherein the output member is not in contact with a dynamic interfacing component (e.g., seal or bearing) that is also interfaced with the input member or members may ultimately be more complex, heavier, have more inertia and/or may cost more than MR fluid actuators with dynamic interfacing component between input and output components. Nevertheless, in some applications where parasitic forces must be reduced or avoided, it may be an advantage to adopt the proposed embodiments.

1. A magnetorheological fluid clutch apparatus comprising:
a structure;
an input assembly including
an input member rotatably mounted to the structure to rotate relative to the structure, and
at least one input shear surface rotating with the input member;
an output assembly including
an output member rotatably mounted to the structure to rotate relative to the structure, and
at least one output shear surface rotating with the output member, the at least
one output shear surface opposite the at least one input shear surface;
at least one annular space separating the shear surfaces;
magnetorheological (MR) fluid in an MR fluid chamber including the at least one annular space, the MR fluid configured to transmit a variable amount of torque between the input assembly and the output assembly when subjected to a magnetic field;
at least one coil actuatable to deliver a magnetic field through the MR fluid in the annular space, the magnetic field controllable to transmit a variable amount of torque from the input assembly to the output assembly;
wherein a totality of seal(s) and bearing(s) contacting the output assembly are between the output assembly and the structure.

2. The magnetorheological fluid clutch apparatus according to claim 1, wherein the input assembly includes input drums, and the at least one input shear surface is on the input drums.

3. The magnetorheological fluid clutch apparatus according to claim 2, wherein the output assembly includes output drums, and the at least one output shear surface is on the output drums.

4. The magnetorheological fluid clutch apparatus according to claim 3, wherein the output drums are intertwined with the input drums, with the annular spaces therebetween.

5. The magnetorheological fluid clutch apparatus according to claim 1, wherein the input assembly includes an input rotor forming an outer casing of the MR fluid clutch apparatus.

6. The magnetorheological fluid clutch apparatus according to claim 5, wherein the MR fluid chamber is delimited outwardly by the input rotor.

7. The magnetorheological fluid clutch apparatus according to claim 6, wherein the structure has support portion thereof delimiting the MR fluid chamber.

8. The magnetorheological fluid clutch apparatus according to claim 7, wherein the support portion is connected to the input rotor by at least one bearing, and connected to the output member by at least one other bearing.

9. The magnetorheological fluid clutch apparatus according to claim 98, including a seal between the MR fluid chamber and the bearing, and another seal between the MR fluid chamber and the other bearing.

10. The magnetorheological fluid clutch apparatus according to claim 1, wherein the output assembly includes an output rotor forming an outer casing of the MR fluid clutch apparatus.

11. The magnetorheological fluid clutch apparatus according to claim 10, wherein the MR fluid chamber is delimited outwardly by the output rotor.

12. The magnetorheological fluid clutch apparatus according to claim 11, wherein a total of friction forces between the output assembly and the structure is higher than viscous forces generated at the shear surface of the MR fluid clutch apparatus in a slippage mode.

13. The magnetorheological fluid clutch apparatus according to claim 1, wherein the MR fluid clutch apparatus is without any dynamic interface component directly between the input assembly and the output assembly.

14. A haptic magnetorheological (MR) fluid actuator unit comprising:
at least one torque source;
a structure;
at least a pair of magnetorheological fluid clutch apparatuses, each of the magnetorheological fluid clutch apparatuses having:
an input assembly including
an input member rotatably mounted to the structure to rotate relative to the structure, and
at least one input shear surface rotating with the input member;
an output assembly including
an output member rotatably mounted to the structure to rotate relative to the structure, and
at least one output shear surface rotating with the output member, the at least one output shear surface opposite the at least one input shear surface;
at least one annular space separating the shear surfaces;
magnetorheological (MR) fluid in an MR fluid chamber including the at least one annular space, the MR fluid configured to transmit a variable amount of torque between the input assembly and the output assembly when subjected to a magnetic field; and
at least one coil actuatable to deliver a magnetic field through the MR fluid in the annular space, the magnetic field controllable to transmit a variable amount of torque from the input assembly to the output assembly;
wherein the output member of the pair of magnetorheological fluid clutch apparatuses being a common output member;
wherein a totality of seal(s) and bearing(s) contacting the output assembly are between the output assembly and the structure.

15. The haptic magnetorheological (MR) fluid actuator unit according to claim 14, wherein the input assembly includes input drums, and the at least one input shear surface is on the input drums.

16. The haptic magnetorheological (MR) fluid actuator unit according to claim 15, wherein the output assembly includes output drums, and the at least one output shear surface is on the output drums.

17. The haptic magnetorheological (MR) fluid actuator unit according to claim 16, wherein the output drums are intertwined with the input drums, with the annular spaces therebetween.

18. The haptic magnetorheological (MR) fluid actuator unit according to claim 14, wherein the common output member includes an output rotor forming an outer casing of the MR fluid clutch apparatuses.

19. (canceled)

20. The haptic magnetorheological (MR) fluid actuator unit according to claim 14 wherein a total of friction forces between the output assembly and the structure is higher than viscous forces generated at the shear surface of the MR fluid clutch apparatus in a slippage mode.

21. The haptic magnetorheological (MR) fluid actuator unit according to claim 14, wherein the MR fluid clutch apparatus is without any dynamic interface component directly between the input assembly and the output assembly.

22.-24. (canceled)
